(19) United States
(12) Patent Application Publication
(10) Pub. No.: US 2012/0019347 A1
(43) Pub. Date: Jan. 26, 2012

(54) Fuse Link Auxiliary Tube Improvement

(75) Inventor: Gary Lee Goedde, Neshkoro, WI (US)

(73) Assignee: COOPER TECHNOLOGIES COMPANY, Houston, TX (US)

(21) Appl. No.: 13/186,223

(22) Filed: Jul. 19, 2011

Related U.S. Application Data
(60) Provisional application No. 61/365,892, filed on Jul. 20, 2010.

(51) Int. Cl. H01H 85/165; H01H 69/02

(52) U.S. Cl. 337/246; 29/623

(57) ABSTRACT

A fuse link auxiliary tube comprises at least one inner layer of paper, at least one layer of polymer film over the at least one inner layer of paper, and at least one outer layer of paper over the at least one layer of polymer film. The at least one inner layer of paper, the at least one layer of polymer film, and the at least one outer layer of paper are wound into a tube shape. An acrylate or acetate layer over the at least one outer layer of paper may be used to structurally reinforce the fuse link auxiliary tube. The paper may be high dielectric strength Kraft paper, fish paper, etc. The polymer film may be polyester film, e.g., MYLAR®.

### RELATED PATENT APPLICATION

This application claims priority to commonly owned U.S. Provisional Patent Application Ser. No. 61/365,892; filed Jul. 20, 2010; entitled “Fuse Link Auxiliary Tube Improvement,” by Gary Lee Goedde; and is hereby incorporated by reference herein for all purposes.

### TECHNICAL FIELD

The present invention relates generally to electrical circuit over-current interruption devices, and more particularly, to high voltage fuse links used in cutouts that have improved low current arc interruption capabilities.

### BACKGROUND

High voltage dropout fuse cutouts and load break fuse cutouts are generally used in outdoor electrical power distribution applications. These dropout fuse cutouts are generally mounted on electrical power utility poles in a fixture that allows the dropout fuse cutouts to be used to open and close power circuits and be removed and replaced with a long insulated pole having a hook on one end and operated from the ground or from a bucket truck. The dropout fuse cutouts are used primarily to protect distribution transformers, power factor correction capacitors, or distribution power lines from short circuits and overloads thereto.

A dropout fuse cutout comprises an insulator support and a fuse tube/door. Static electrical contacts are fixed on two sides of the insulator support and moving electrical contacts are located at both ends of an insulated fuse tube. The fuse tube comprises an arc ablative inner liner with a filament wound over wrap for high current interruption performance. The fuse door is comprised of electrical contacts at each end, a fuse link auxiliary tube inside of the outer fuse tube, and at least one series-connected electrically conductive fuse element inside of the fuse link auxiliary tube. The fuse link electrically couples the contacts at each end of the fuse tube. The fuse link auxiliary tube encases the fuse link and is used to improve low current fault arc-extinguishing. The fuse link and auxiliary tube may also be used in a multi-phase fuse assembly having fuse cutout doors.

Fuse links are used in combination with the fuse cutouts to interrupt overload and fault currents on high voltage electrical distribution systems, e.g., 15, 27 and 38 kV class distribution systems. The cutout/fuse link combination is required by ANSI standards to interrupt five levels of current by cooling the arc and providing a dielectric gap after the fuse link melts. The fuse cutout door has a liner for the fault interruptions at thousands of amperes.

Fuse link auxiliary tubes aid in low current interruptions, e.g., less than 1000 amperes, in distribution-class fuse cutouts. They are typically made with an inner liner of fish paper, which is an ablative material that aids in interrupting an electrical arc at low currents, e.g., less than 100 amperes. Historically, fish paper was made from denim (cotton) fibers and performance was adequate up to 38 kV. However, now, fish paper is primarily made from wood pulp and its performance is susceptible to dry atmospheric conditions. The use of wood pulp fibers has compromised consistent low current arc interruption performance of distribution-class fuse cutouts, e.g., 15, 27 and 38 kV, because the electrical arc extinguishing performance of these wood pulp fiber auxiliary tubes is more susceptible to atmospheric humidity conditions. When the humidity is low, the wood pulp fiber of the auxiliary tube is dry (lacks moisture content). Having sufficient moisture content in the auxiliary tube is important as the moisture, during a low level fault, will turn into steam that helps to extinguish an electrical arc more quickly, i.e., in fewer cycles. When the auxiliary tube lacks sufficient moisture content, the fuse link will arc for additional phase cycles during a low current fault, resulting in poor interruption and arc suppression performance.

Present technology paper auxiliary tube performance is dependent on the humidity conditions when the fuse links are manufactured and their exposure to humidity before testing. Therefore, performance could only be artificially adjusted by control of the environment (humidity and temperature). In addition, the high resistance (low current leakage) quality of the fish paper in general had to be improved through washing and subsequent removal of ionic contaminants (such as sodium).

### SUMMARY

Therefore, what is needed is a way of reducing the effects of atmospheric humidity conditions on fault current performance of a fuse link auxiliary tube. Unlike currently used materials for fuse link auxiliary tubes where dry conditions mean reduced performance, the materials and methods of construction of the fuse link auxiliary tube disclosed herein show improved performance under dry, low humidity conditions. Thus an additional benefit of the fuse link auxiliary tube disclosed herein provides performance stability over all levels of environmental humidity conditions.

According to the teachings of this disclosure, a laminate of Kraft fiber (paper) sheet and polymer film (specifically a polyester film) is used to construct the fuse link auxiliary tube. The inclusion of the polyester film facilitates both arc-quenching and improved tube mechanical strength. The use of this fuse link auxiliary tube having a sandwich structure comprised of a first layer of Kraft paper, a layer of polyester film, and a second layer of Kraft paper provides excellent interruption performance for ANSI C37.41-20008 Table 5, Series 5 testing, incorporated by reference herein for all purposes. The decomposition of the polyester film layer may include liberation of moisture that cools the electric arc and aids in the interruption of current as well as generation of gas pressure to assist in the electric arc quenching. The film layer also provides additional mechanical strength to the overall tube matrix. It is contemplated and within the scope of this disclosure that any film that can liberate moisture in the form of vapor or steam in the presence of an electrical arc and that provides additional mechanical strength to the overall tube matrix may be used as described herein.

Another embodiment may comprise fish paper inner and outer layers and a polymer film layer therebetween. The outside diameter (OD) of this fuse link auxiliary tube can be wrapped with acetate if increased burst strength is required to meet ANSI Series 3 and 4 interruption performance requirements.

According to the teachings of this disclosure, a fuse link auxiliary tube may comprise at least one inner layer of paper, at least one layer of polymer film over the at least one inner layer of paper, and at least one outer layer of paper over the at least one layer of polymer film. An acrylate or acetate layer over the at least one outer layer of paper may be used to reinforce the fuse link auxiliary tube structure. The paper may be for example, but is not limited to, high dielectric strength Kraft paper, fish paper, etc. The polymer film may be for example, but is not limited to, polyester film, e.g., MYLAR®.

The fuse link auxiliary tube may be formed over a mandrel by diagonally wrapping multiple layers at a time over the mandrel to produce a continuous length of tube. This continuous length of tube can be cut to desired lengths during fabrication and/or subsequent layers can be added to build the tube wall to a thickness and strength required to pass the arc interruption tests. Radially winding these layers onto the mandrel is also contemplated and within the scope of this disclosure, as well as filament over-wrapping and over-molding the initial layers of Kraft-Mylar-Kraft.

According to a specific example embodiment of this disclosure, a fuse link auxiliary tube comprises: at least one inner layer of paper; at least one layer of polymer film over the at least one inner layer of paper; and at least one outer layer of paper over the at least one layer of polymer film, wherein the at least one inner layer of paper, the at least one layer of polymer film, and the at least one outer layer of paper are wound into a tube shape.

According to another specific example embodiment of this disclosure, a method of forming a fuse link auxiliary tube comprises the steps of: forming at least one inner layer of paper into a tube shape; forming at least one layer of polymer film over the at least one inner layer of paper; and forming at least one outer layer of paper over the at least one layer of polymer film.

### BRIEF DESCRIPTION OF THE DRAWINGS

For a more complete understanding of the present invention and the advantages thereof, reference is now made to the following description, in conjunction with the accompanying figures briefly described as follows.

FIGS. 1A and 1B illustrate a typical fuse link having an auxiliary tube, according to the teachings of this disclosure;

FIG. 2 illustrates a single outdoor pole mounted dropout fuse cutout, according to the teachings of this disclosure; and

FIG. 3 illustrates a cutout end view of a fuse link auxiliary tube, according to a specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, details of a specific example embodiment of the present invention are schematically illustrated. Like elements in the drawings will be represented by like numbers, and similar elements will be represented by like numbers with a different lower case letter suffix.

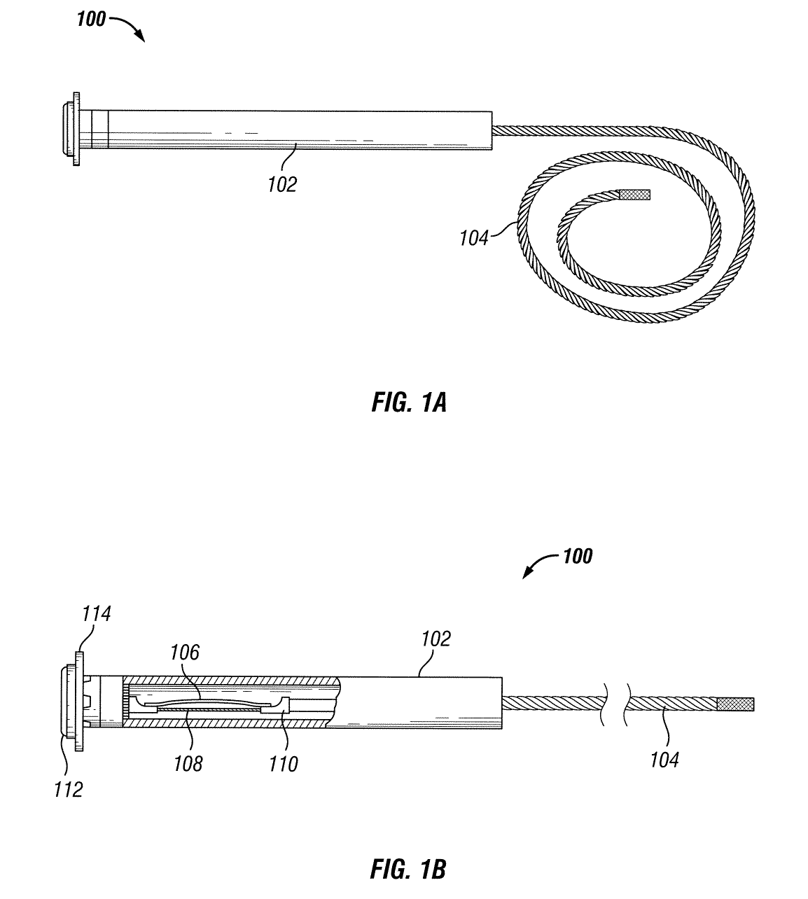

Referring to FIG. 1, depicted is a typical fuse link having an auxiliary tube, according to the teachings of this disclosure. A fuse link (“Edison or Kearney link,”) generally represented by the numeral 100, comprises a fuse link auxiliary tube 102 and a flexible leader wire 104 as shown in FIG. 1 A. FIG. 1B illustrates a cutaway view of a typical fuse link 100 comprising a fuse element 106, a strain wire 108, a ferrule 110, a button head 112 and a captive washer 114. The strain wire 108 provides tension relief for the fuse element 106, and the ferrule 110 provides for electrically and mechanically connecting the fuse element 106 and strain wire 108 to the leader wire 104. The fuse link auxiliary tube 102 slips over the leader wire 104 and is held in place by a mechanical interference fit at the button head 112 end. The fuse link auxiliary tube 102 surrounds the fuse element 106 and will generate a release of gas/vapor during a low current fault to help extinguish the plasma arc occurring when the fuse element 106 melts during the current overload.

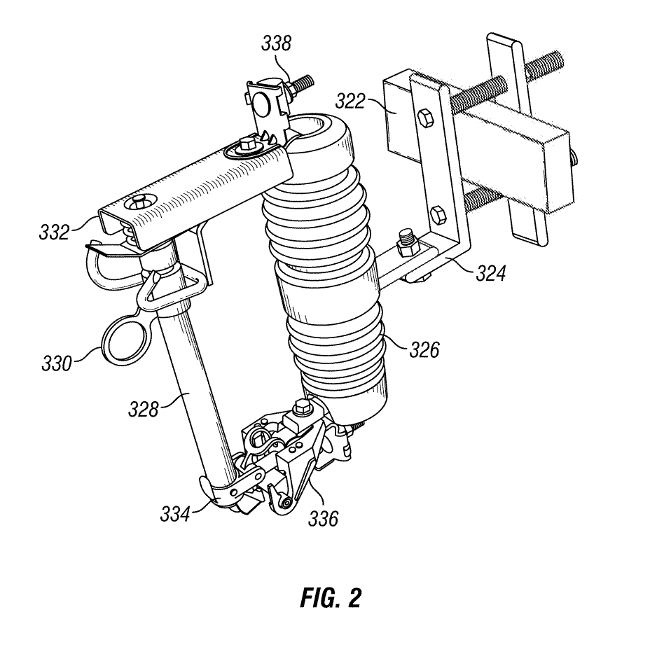

Referring to FIG. 2, depicted is a single outdoor pole mounted dropout fuse cutout, according to the teachings of this disclosure. The fuse link 100 is contained within a fuse body 328. The fuse body 328 has conductive ends that mate with a fixed contact 334 and a moveable contact 332 held rigidly apart at the ends of an insulator 326. A push/pull eye hook 330 is also at the same end of the fuse body 328 as the moveable contact 332 and is used to connect and disconnect the fuse body 328 from the contacts 332 and 334. The insulator 326, contacts 332 and 334, and fuse body 328 may be attached to a power pole cross arm 322 with a mounting bracket 324. A line connection is made at connection point 338 and a load connection is made at connection point 336.

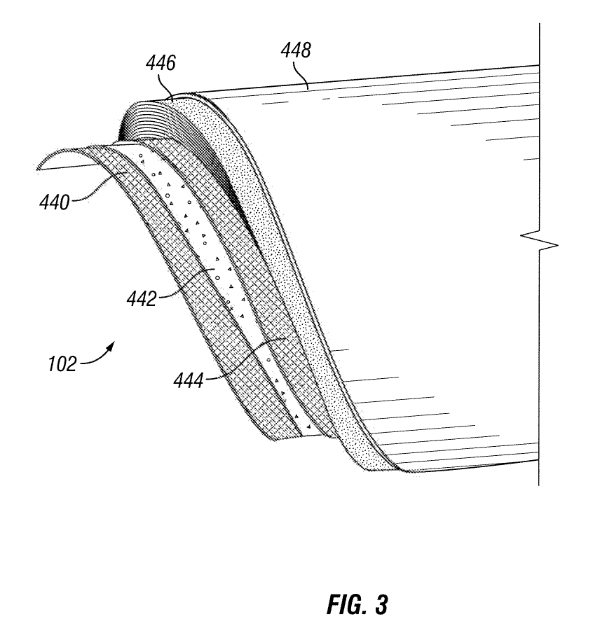

Referring to FIG. 3, depicted is a cutout end view of a fuse link auxiliary tube, according to a specific example embodiment of this disclosure. The fuse link auxiliary tube 102 comprises an inner first paper layer 440, a polyester film layer 442 wrapped over the inner first paper layer 440, and a second paper layer 444 wrapped over the polyester film layer 442. Optionally, at least one additional third paper layer 446 and/or an outer acetate layer 448 may be wrapped over the second paper layer 444. If no third paper layer 446 is used then the outer layer 448 is wrapped over the second paper layer 444. If the third paper layer 446 is used then the outer layer 448 is wrapped over the third paper layer 446.

A laminate of Kraft fiber (paper) sheet and polymer film, preferably a polyester film, is used to construct the fuse link auxiliary tube 102. The inclusion of the polyester film layer 442 facilitates both arc-quenching and improved fuse link auxiliary tube 102 mechanical strength. The use of this fuse link auxiliary tube 102 having a sandwich structure comprised of a first layer of Kraft paper (440), a layer of polyester film (442), and a second layer of Kraft paper (444) provides excellent interruption performance for ANSI C37.41-20008 Table 5, Series 5 testing, incorporated by reference herein for all purposes. The decomposition of the polyester film layer 442 may include liberation of moisture that cools the electric arc and aids in the interruption of current as well as generation of gas pressure to assist in the electric arc quenching. The polyester film layer 442 also provides additional mechanical strength to the overall structural matrix of the fuse link auxiliary tube 102.

Kraft paper is paper produced from the chemical pulp of softwood processed by the kraft process. It is strong and relatively coarse. The grammage is normally from about 50-135 g/cm². Kraft paper is usually a brown color but can be bleached to produce white paper. It is used for paper grocery bags, multiwall sacks, envelopes and other packaging (www.Wikipedia.org). Preferably the Kraft paper used is high dielectric strength Kraft paper.

A sandwich of Kraft paper, polyester and Kraft paper used as the layers of the auxiliary tube 102 provides excellent interruption performance at 15.5, 27 and 38 kV, and is not susceptible to dry atmospheric conditions. Polyesters such as MYLAR (R) (a registered trademark of E. I. Du Pont De Nemours and Company Corporation, Delaware 1007 Market Street, Wilmington, Del. 19898) will provide improvements in the low current interruption performance as well by cooling the arc and allowing the current to be interrupted. The Kraft-polyester-Kraft sandwich thicknesses may be, for example but are not limited to, about two mils for each of the Kraft paper layers 440 and 444, and about one or two mils for the polyester film layer 442.

Another embodiment may comprise fish paper for the first and second paper layers 440 and 444 with a polymer film layer 442 therebetween. The outside diameter (OD) of this fuse link auxiliary tube 102 can be wrapped with an acetate layer 448 if increased burst strength is required to meet ANSI Series 3 and 4 interruption performance requirements. Preferably the fish paper used is high dielectric strength fish paper.

The fuse link auxiliary tube 102 may be formed over a mandrel (not shown) by diagonally wrapping one or more layers at a time over the mandrel to produce a required length of the fuse link auxiliary tube 102. Subsequent layers may then be diagonally wrapped over the one or more of layers after adhesive is applied therebetween, e.g., applied to either or both of the layers to be joined at a time. The fuse link auxiliary tube 102 may also be formed over a mandrel (not shown) by diagonally wrapping multiple layers at a time over the mandrel to produce a continuous length of tube. This continuous length of tube can be cut to desired lengths during fabrication and/or subsequent layers can be added to build the tube wall to a thickness and strength required to pass the arc interruption tests. Radially winding these layers onto the mandrel is also contemplated and within the scope of this disclosure, as well as filament over-wrapping and over-molding the initial layers of Kraft-Mylar-Kraft.

Adhesives used between the paper and polymer film layers may be for example, but are not limited to, polyvinyl acetate (PVA), resin emulsions, cross-linked PVA adhesives and the like.

Although specific example embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

I claim:

1. A fuse link auxiliary tube, comprising:
at least one inner layer of paper;
at least one layer of polymer film over the at least one inner layer of paper; and
at least one outer layer of paper over the at least one layer of polymer film,
wherein the at least one inner layer of paper, the at least one layer of polymer film, and the at least one outer layer of paper are wound into a tube shape.

2. The fuse link auxiliary tube according to claim 1, wherein the paper is fish paper.

3. The fuse link auxiliary tube according to claim 1, wherein the paper is Kraft paper.

4. The fuse link auxiliary tube according to claim 1, wherein the polymer film is a polyester film.

5. The fuse link auxiliary tube according to claim 1, further comprising an acrylate layer over the at least one outer layer of paper, wherein the acrylate layer structurally reinforces the fuse link auxiliary tube.

6. The fuse link auxiliary tube according to claim 1, wherein the inner and outer layers of paper are each about two (2) mils thick.

7. The fuse link auxiliary tube according to claim 1, wherein the polymer film is from about one (1) mil to about two (2) mils thick.

8. The fuse link auxiliary tube according to claim 1, wherein the polymer film is about one (1) mil thick.

9. The fuse link auxiliary tube according to claim 1, wherein the at least one inner layer of paper, the at least one layer of polymer film, and the at least one outer layer of paper are spirally wound into a tube shape.

10. The fuse link auxiliary tube according to claim 1, wherein the at least one inner layer of paper, the at least one layer of polymer film, and the at least one outer layer of paper are spirally wound over a mandrel into a tube shape.

11. The fuse link auxiliary tube according to claim 1, wherein the at least one inner layer of paper, the at least one layer of polymer film, and the at least one outer layer of paper have adhesive applied therebetween when winding into a tube shape.

12. The fuse link auxiliary tube according to claim 11, wherein the adhesive is selected from the group consisting of polyvinyl acetate (PVA), resin emulsions, and cross-linked PVA adhesives.

13. The fuse link auxiliary tube according to claim 1, further comprising at least one acetate layer over the at least one outer layer of paper.

14. A method of forming a fuse link auxiliary tube, comprising the steps of:
forming at least one inner layer of paper into a tube shape;
forming at least one layer of polymer film over the at least one inner layer of paper; and
forming at least one outer layer of paper over the at least one layer of polymer film.

15. The method according to claim 14, further comprising the step of forming at least one acetate layer over the at least one outer layer of paper.

16. The method according to claim 14, wherein the step of forming the at least one inner layer of paper into a tube shape comprises the step of wrapping the at least one inner layer of paper over a mandrel.

17. The method according to claim 16, wherein the step of wrapping comprises the step of diagonally winding the at least one inner layer of paper over the mandrel.

18. The method according to claim 16, wherein the step of wrapping comprises the step of radially winding the at least one inner layer of paper over the mandrel.

19. The method according to claim 14, when the at least one inner layer of paper, the at least one layer of polymer film and the at least one outer layer of paper are diagonally wound over a mandrel concurrently.

20. The method according to claim 14, when the at least one inner layer of paper, the at least one layer of polymer film and the at least one outer layer of paper are radially wound over a mandrel concurrently.
